(19) United States
(12) Patent Application Publication
(10) Pub. No.: US 2023/0323025 A1
(43) Pub. Date: Oct. 12, 2023

(54) ALIPHATIC COPOLYCARBONATE AND PREPARATION METHOD THEREOF

(71) Applicant: Chengdu Organic Chemistry Co., Ltd., Chinese Academy Of Sciences, Chengdu (CN)

(72) Inventors: GONGYING WANG, CHENGDU (CN); QIDING RAN, CHENGDU (CN); JIANGUO LI, CHENGDU (CN); QINGYIN WANG, CHENGDU (CN); SHAOYING LIU, CHENGDU (CN)

(21) Appl. No.: 18/058,745

(22) Filed: Nov. 24, 2022

Related U.S. Application Data
(63) Continuation of application No. PCT/CN2022/099118, filed on Jun. 16, 2022.

(30) Foreign Application Priority Data
Apr. 8, 2022 (CN) 202210364321.4

(51) Int. Cl. C08G 64/02

(52) U.S. Cl. CPC C08G 64/0208

(57) ABSTRACT

An aliphatic copolycarbonate and a preparation method thereof are disclosed. The aliphatic copolycarbonate contains a structural unit represented by formula (1) and a structural unit represented by formula (2):

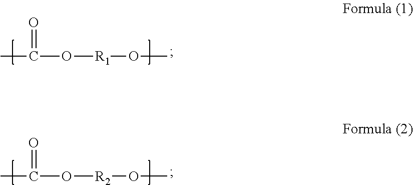

where R₁ is a C₃-C₁₀ alkylene group, and R₂ is an alicyclic group. In the present disclosure, a specific alicyclic monomer is introduced into the aliphatic polycarbonate molecular chain to obtain a novel aliphatic copolycarbonate. The polymer in the present disclosure has properties such as relatively high melting point, glass transition temperature and thermal stability, and has better thermal properties.

### CROSS-REFERENCE TO RELATED APPLICATIONS

This application is a continuation of co-pending International Patent Application Number PCT/CN2022/099118, filed on Jun. 16, 2022, the disclosure of which is incorporated herein by reference in its entirety.

### TECHNICAL FIELD

This disclosure relates to the technical field of polymer synthesis, and more particularly relates to an aliphatic copolycarbonate and a preparation method thereof.

### BACKGROUND

Aliphatic polycarbonate features excellent biodegradability, biocompatibility, and superior physical and chemical properties. Its degradation rate is lower than that of aliphatic polyester, and after degradation, it produces small-molecule alcohols, water-soluble carbonic acid diesters and carbon dioxide, which can be used as biomedical materials. It also provides a new solution for the waste of resources and environmental pollution caused by the use of traditional non-degradable polymers. Due to its long linear molecular chain structure, the aliphatic polycarbonate has relatively low glass transition temperature (Tg) and melting point (Tm), which affect its stability during use, making its promotion and application difficult. Polybutylene carbonate (PBC) is a typical aliphatic polycarbonate with excellent mechanical properties, abundant raw material sources, and low cost, which is conducive to large-scale production. However, it still has the problem of low thermal properties. Therefore, the focus of current research is to modify it to further improve its thermal properties by changing the molecular chain structure.

Invention patent CN103204987B discloses an aliphatic polycarbonate obtained by copolymerization of diphenyl carbonate, 1,4-butanediol, and 1,6-hexanediol (HD), and its number-average molecular weight Mn is 108600 g·mol⁻¹. However, its glass transition temperature and melting temperature are relatively low, which is detrimental to its mechanical properties at high temperatures.

As reported in the literature, 1,6-Hexanediol (J. Macromol. Sci. A, 2011, 48, 583-594) and 1,10-decanediol (DD) (RSC Adv. 2015, 5, 2213-2222) and like linear long-chain monomers were copolymerized with DMC and BD to obtain copolycarbonates PBHC and PBDC, whose thermal stability gradually increases with the increase of HD or DD content, but the introduction of long-chain monomers reduced the Tm and Tg of PBHC and PBDC compared with PBC.

Invention patent CN102746504B discloses a random copolycarbonate obtained by copolymerizing dimethyl carbonate, isosorbide, and 1,4-butanediol, with a number-average molecular weight Mₙ of 28000 g·mol⁻¹, and Tg=118° C. However, the color of the copolycarbonate obtained by the polymerization of isosorbide is prone to yellowing, and the problem of discoloration may also need to be dealt with.

Invention patent CN103265689B discloses a copolymer of aliphatic polycarbonate and aromatic polyester obtained by copolymerization of dimethyl carbonate, 1,4-butanediol and dimethyl terephthalate, and the number-average molecular weight Mₙ is 58400 g·mol⁻¹. However, compounds containing aromatic ring structures are difficult to degrade, which reduces the biodegradability of polymers.

Therefore, how to provide an aliphatic copolycarbonate and improve the properties of the polymer such as melting point, glass transition temperature and thermal stability is the focus of current research.

### SUMMARY

In view of the above problems, it is therefore a purpose of the present disclosure to overcome the deficiencies of the related art and provides an aliphatic copolycarbonate and a preparation method thereof. The present disclosure introduces a specific alicyclic monomer into the aliphatic polycarbonate molecular chain to obtain a novel aliphatic copolycarbonate. The polymer in the present disclosure has properties such as relatively high melting point, glass transition temperature and thermal stability, and has better thermal properties.

One of the objects of the present disclosure is to provide an aliphatic copolycarbonate containing a structural unit represented by formula (1) and a structural unit represented by formula (2);

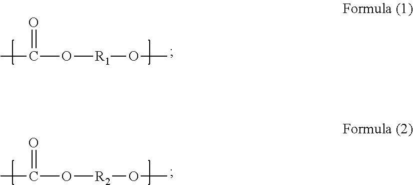

where R₁ is a C₃-C₁₀ alkylene group, and R₂ is an alicyclic group.

According to the present disclosure, R₁ is a C₃-C₁₀ alkylene group. In some embodiments of the present disclosure, R₁ is a C₃-C₁₀ straight-chain alkylene group, that is, R₁ is

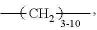

and in some embodiments C₄, C₆, C₈, C₁₀ straight chain alkylene.

According to the present disclosure, R₂ is an alicyclic group, which can be selected from multiple options. In some embodiments of the present disclosure, R₂ is selected from one or more of the following alicyclic groups:

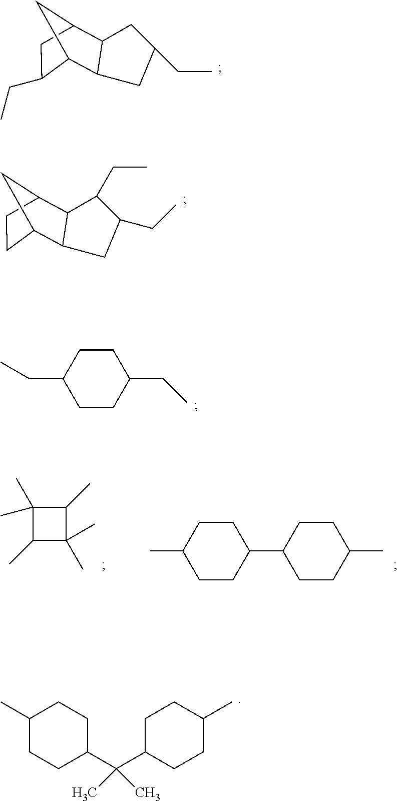

In the present disclosure,

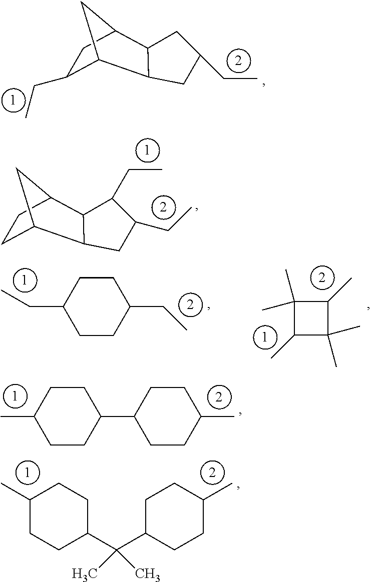

where in each structural formula, □ and □ are covalent bonds.

In some embodiments of the present disclosure, R₂ is selected from one of

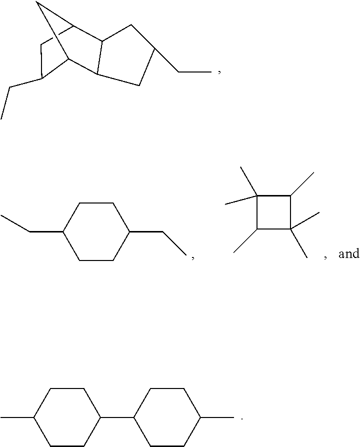

According to the present disclosure, the structural unit represented by the formula (1) and the structural unit represented by the formula (2) have a wide selection range in terms of the molar amount of the aliphatic copolycarbonate. In some embodiments of the present disclosure, based on the total molar amount of structural units in the aliphatic copolycarbonate as 100%, the molar content of the structural unit represented by formula (1) is 10%-90%, and the molar content of the structural unit represented by formula (2) is 10%-90%.

In some embodiments of the present disclosure, when R₂ is

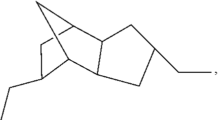

the molar content of the structural unit represented by formula (1) is 10%-80%, and the molar content of the structural unit represented by formula (2) is 20% %-90%. When R₂ is

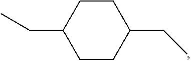

the molar content of the structural unit represented by formula (1) is 10%-80%, and the molar content of the structural unit represented by formula (2) is 20%-90%. When R₂ is

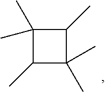

the molar content of the structural unit represented by formula (1) is 10%-60%, and the molar content of the structural unit represented by formula (2) is 40%-90%. When R₂ is

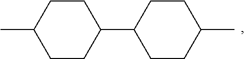

the molar content of the structural unit represented by the formula (1) is 10%-70%, and the molar content of the structural unit represented by the formula (2) is 30%-90%. In the above-mentioned embodiments, the aliphatic copolycarbonate of the present disclosure exhibits a relatively high glass transition temperature and has better thermal properties.

According to the present disclosure, in some embodiments, based on the total molar amount of structural units in the aliphatic copolycarbonate as 100%, the molar content of the structural unit represented by formula (1) is 10%-90%, when R₂ is

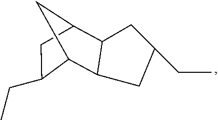

it is in some embodiments 10%-80%, for example, it may be 10%, 20%, 30%, 40%, 50%, 60%, 70%, 80%, or any two values or any interval between any two values. When R₂ is

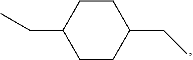

it is in some embodiments 10%-80%, for example, it may be 10%, 20%, 30%, 40%, 50%, 60%, 70%, 80%, or any two values or any interval between any two values. When R₂ is

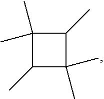

it is in some embodiments 10%-60%, for example, it may be 10%, 20%, 30%, 40%, 50%, 60%, or any two values or any interval between any two values. When R₂ is

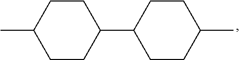

it is in some embodiments 10%-70%, for example, it may be 10%, 20%, 30%, 40%, 50%, 60%, 70%, or any two values or any interval between any two values.

According to the present disclosure, in some embodiments, based on the total molar amount of structural units in the aliphatic copolycarbonate as 100%, the molar content of the structural unit represented by formula (2) is 10%-90%, when R₂ is

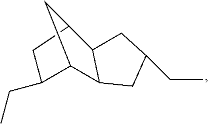

it is in some embodiments 20%-90%, for example, it may be 20%, 30%, 40%, 50%, 60%, 70%, 80%, 90%, or any two values or any interval between any two values. When R₂ is

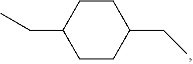

it is in some embodiments 20%-90%, for example, it may be 20%, 30%, 40%, 50%, 60%, 70%, 80%, 90%, or any two values or any interval between any two values. When R₂ is

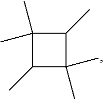

it is in some embodiments 40%-90%, for example, it may be 40%, 50%, 60%, 70%, 80%, 90%, or any two values or any interval between any two values. When R₂ is

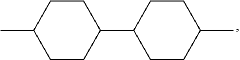

it is in some embodiments 30%-90%, for example, it may be 30%, 40%, 50%, 60%, 70%, 80%, 90%, or any two values or any interval between any two values.

In some embodiments, the sum of the molar content of the structural unit represented by formula (1) and the molar content of the structural unit represented by formula (2) is 100%.

According to the present disclosure, the weight-average molecular weight of the aliphatic copolycarbonate may have a wide selection range. In some embodiments of the present disclosure, the weight-average molecular weight of the aliphatic copolycarbonate is 9×10³-14×10⁴, in some embodiments 2×10⁴-14×10⁴, for example, it may be 2×10⁴, 4×10⁴, 6×10⁴, 8×10⁴, 10×10⁴, 12×10⁴, 14×10⁴, or an interval bound by or within any two values.

In some embodiments of the present disclosure, when R₂ is

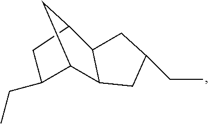

the weight-average molecular weight of the aliphatic copolycarbonate is 3×10⁴-14×10⁴.

In some embodiments of the present disclosure, when R₂ is

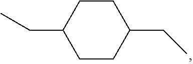

the weight-average molecular weight of the aliphatic copolycarbonate is 8×10⁴-14×10⁴.

In some embodiments of the present disclosure, when R₂ is

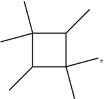

the weight-average molecular weight of the aliphatic copolycarbonate is 2×10⁴-14×10⁴.

In some embodiments of the present disclosure, when R₂ is

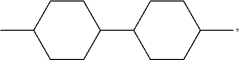

the weight-average molecular weight of the aliphatic copolycarbonate is 3×10⁴-14×10⁴.

According to the present disclosure, the number-average molecular weight of the aliphatic copolycarbonate has a wide selection range. In some embodiments of the present disclosure, the number-average molecular weight of the aliphatic copolycarbonate is 5×10³-8×10⁴, in some embodiments 1×10⁴-8×10⁴, for example, it may be 1×10⁴, 2×10⁴, 4×10⁴, 6×10⁴, 8×10⁴, or an interval bound by or within any two values.

According to the present disclosure, the polydispersity index of the aliphatic copolycarbonate has a wide selection range. In some embodiments of the present disclosure, the polydispersity index of the aliphatic copolycarbonate is 1.5-2.1, in some embodiments 1.5-2.1. 1.59-1.89.

In some embodiments of the present disclosure, when R₂ is

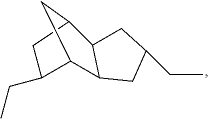

the number-average molecular weight of the aliphatic copolycarbonate is 2×10⁴-8×10⁴.

In some embodiments of the present disclosure, when R₂ is

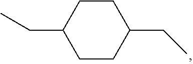

the number-average molecular weight of the aliphatic copolycarbonate is 4×10⁴-8×10⁴.

In some embodiments of the present disclosure, when R₂ is

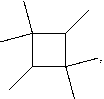

the number-average molecular weight of the aliphatic copolycarbonate is 1×10⁴-8×10⁴.

In some embodiments of the present disclosure, when R₂ is

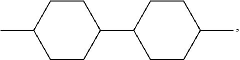

the number-average molecular weight of the aliphatic copolycarbonate is 1×10⁴-8×10⁴.

In some embodiments of the present disclosure, the glass transition temperature of the aliphatic copolycarbonate is (−30.29)-70.9° C., in some embodiments 0-70.90° C., measured and analyzed by differential scanning calorimetry.

In some embodiments of the present disclosure, according to thermogravimetric analysis, the 5% thermal weight loss temperature of the aliphatic copolycarbonate is 270.71-330.79° C., in some embodiments 271-330° C.

In some embodiments of the present disclosure, according to thermogravimetric analysis, the temperature of the maximum thermogravimetric loss rate of the aliphatic copolycarbonate is 306.73-392.45° C., in some embodiments 307-392° C.

A second object of the present disclosure is to provide a preparation method of the aforementioned aliphatic copolycarbonate, comprising the following operations.

(1) In the presence of a catalyst and in an inert atmosphere, the diol monomer represented by the formula (3), the diol monomer represented by the formula (4), and the carbonate monomer are subjected to melt polycondensation to obtain a prepolymerized product;

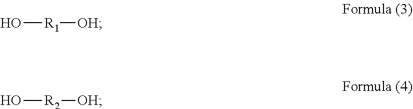

(2) By-products in the prepolymerized product obtained in operation (1) are removed, and then a polymerization reaction is performed to obtain the aliphatic copolycarbonate.

According to the present disclosure, the selection range of the prepolymerization conditions in operation (1) is wide. In some embodiments of the present disclosure, the prepolymerization conditions in operation (1) include: the temperature is 140-220° C.

According to the present disclosure, the selection range of the reaction time of the prepolymerization in operation (1) is wide. In some embodiments of the present disclosure, the reaction time is 1-5 hours.

According to the present disclosure, the inert atmosphere may be provided by, but not limited to, nitrogen and/or inert gas.

According to the present disclosure, the selection range of the polymerization conditions in operation (2) is wide. In some embodiments of the present disclosure, the polymerization conditions in operation (2) include: the temperature is 150-240° C.

According to the present disclosure, the polymerization time in operation (2) can be selected from a wide range, and in some embodiments of the present disclosure, the time is 1-5 hours.

According to the present disclosure, the selection range of the pressure for polymerization in operation (2) is wide. In some embodiments of the present disclosure, the pressure is not higher than 200 Pa, in some embodiments 10-150 Pa, such as 10 Pa, 30 Pa, 60 Pa, 90 Pa, 120 Pa, 150 Pa, or an interval bound by or within any two values.

In some embodiments of the present disclosure, the method for removing by-products in the prepolymerized product obtained in operation (1) is vacuum distillation, in some embodiments the temperature of the vacuum distillation is 150-240° C., and the pressure is 2×10²-2×10⁴ Pa.

According to the present disclosure, the selection range of the ratio of the total molar amount of the carbonate monomer to that of the diol monomer represented by the formula (3) and the diol monomer represented by the formula (4) is wide. In some embodiments of the disclosure, the ratio of the total molar amount of the carbonate monomer to the total molar amount of the diol monomer represented by the formula (3) and the diol monomer represented by the formula (4) is 1:(1-1.5).

According to the present disclosure, in the diol monomer represented by formula (3), R₁ is a C₃-C₁₀ alkylene group, and in the diol monomer represented by formula (4), R₂ is an alicyclic group.

According to the present disclosure, R₁ is a C₃-C₁₀ alkylene group, in some embodiments of the present disclosure, R₁ is a C₃-C₁₀ straight-chain alkylene group, in some embodiments a C₄, C₆, C₈, C₁₀ straight-chain alkylene group alkyl.

According to the present disclosure, R₂ is an alicyclic group, which can be selected from multiple options. In some embodiments of the present disclosure, R₂ is selected from one or more of the following alicyclic groups:

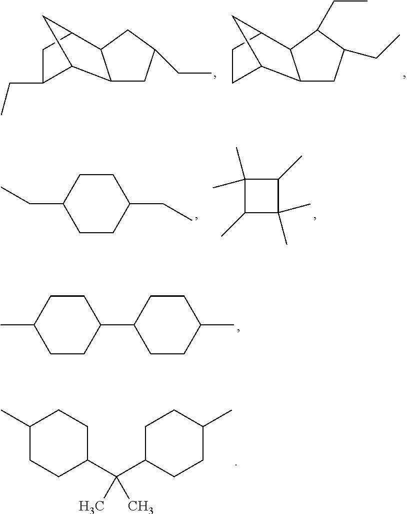

In some embodiments of the present disclosure, R₂ is selected from one of

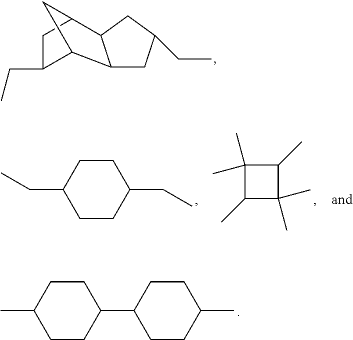

According to the present disclosure, the selection range of the ratio of the diol monomer represented by the formula (3) and the diol monomer represented by the formula (4) is wide. In some embodiments of the present disclosure, the amounts of the diol monomer represented by the formula (3) and the diol monomer represented by the formula (4) are such that: taking the total molar amount of structural units in the aliphatic copolycarbonate as 100%, the molar content of the structural unit represented by formula (1) is 10%-90%, when R₂ is

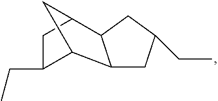

in some embodiments 10%-80%, for example, it may be 10%, 20%, 30%, 40%, 50%, 60%, 70%, 80%, or an interval bound by or within any two values; when R₂ is

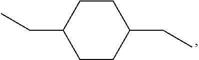

it is in some embodiments 10%-80%, for example, it may be 10%, 20%, 30%, 40%, 50%, 60%, 70%, 80%, or an interval bound by or within any two values; When R₂ is

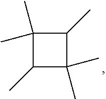

it is in some embodiments 10%-60%, for example, it may be 10%, 20%, 30%, 40%, 50%, 60%, or an interval bound by or within any two values; When R₂ is

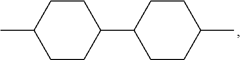

it is in some embodiments 10%-70%, for example, it may be 10%, 20%, 30%, 40%, 50%, 60%, 70%, or an interval bound by or within any two values. The molar content of the structural unit represented by formula (2) is 10%-90%, when R₂ is

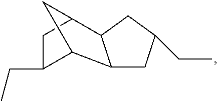

in some embodiments 20%-90%, for example, it may be 20%, 30%, 40%, 50%, 60%, 70%, 80%, 90%, or an interval bound by or within any two values; When R₂ is

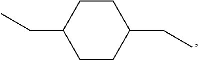

it is in some embodiments 20%-90%, for example, it may be 20%, 30%, 40%, 50%, 60%, 70%, 80%, 90%, or an interval bound by or within any two values; When R₂ is

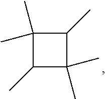

it is in some embodiments 40%-90%, for example, it may be 40%, 50%, 60%, 70%, 80%, 90%, or an interval bound by or within any two values; When R₂ is

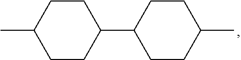

it is in some embodiments 30%-90%, for example, it may be 30%, 40%, 50%, 60%, 70%, 80%, 90%, or an interval bound by or within any two values.

According to the present disclosure, the content of each structural unit in the aliphatic copolycarbonate can be detected by using a conventional detection method in the art, and can also be calculated by using the feeding amount. In the present invention, the molar content of each structural unit is calculated by the feeding amount.

In some embodiments of the present disclosure, the diol monomer represented by formula (4) is selected from at least one of the following compounds:

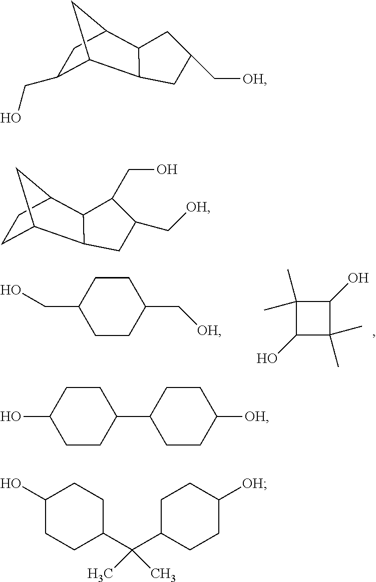

the diol monomer represented by the formula (4) is more in some embodiments at least one of

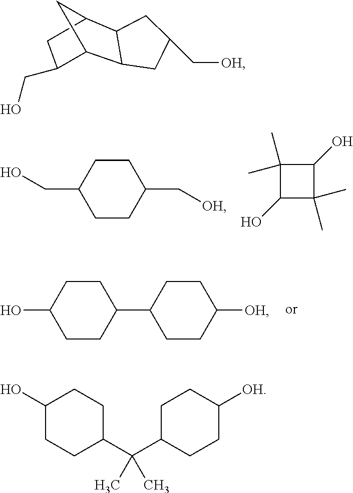

According to the present disclosure, the selection range of the carbonate monomer is wide. In some embodiments of the present disclosure, the carbonate monomer is selected from at least one of dimethyl carbonate, diethyl carbonate, dipropyl carbonate, dibutyl carbonate, dihexyl carbonate, dioctyl carbonate, ethyl methyl carbonate, and diphenyl carbonate.

According to the present disclosure, the catalyst has a wide selection range. In some embodiments of the present disclosure, the catalyst is selected from one or more of oxide-type solid bases, inorganic metal salts and organic bases. In some embodiments, the oxide-type solid base is an oxide of Mg or Ca, or the oxide-type solid base is a composite oxide of Mg and Ca, in some embodiments the size is ≤100 nm. Inorganic metal salts are acetate compounds of at least one of Mg, Ca, Mn, Co, Cu, Zn, and Cd. The organic base is at least one of sodium methoxide, sodium ethoxide, triethylamine and/or triphenylamine.

According to the present disclosure, the selection range of the amount of the catalyst is wide. In some embodiments of the present disclosure, based on the total molar amount of the diol monomer represented by the formula (3) and the diol monomer represented by the formula (4) or the molar amount of the carbonate monomer as 100 parts, the amount of the catalyst used is 0.1-1 part.

In some embodiments of the present disclosure, the method for preparing the aliphatic copolycarbonate comprises the following operations:

(1) In an inert gas atmosphere, the diol monomer represented by formula (3) and the diol monomer represented by formula (4), carbonate monomer, and the catalyst are placed in a reactor in proportions at the same time, and subjected to heating, melting and mixing evenly, thus raising the temperature to 140-220° C., and the reaction time is 1-5 hours to obtain an oligomeric product;

(2) Raise the temperature of the oligomerization product obtained in operation (1) to 150-240° C., while gradually reducing the pressure in the reactor, after the by-products are distilled off under reduced pressure, then reduce the pressure in the reactor to below 200 Pa, in some embodiments 10-150 Pa, and react for 1-5 hours to obtain aliphatic copolycarbonate.

By adopting the above-mentioned technical scheme, the beneficial effects of the present disclosure are as follows.

Compared with the related art, the melting point, glass transition temperature and thermal stability of the polymer in the present disclosure are improved, and the mechanical strength is also improved.

The reason for the above advantages is that the inventors of the present disclosure have verified through research that the reason lies in the specific structure in the molecular chain of the aliphatic copolycarbonate of the present disclosure, that is, the repeating unit containing a cyclic structure (more in some embodiments the repeating unit in some embodiments having a cyclic structure in the present disclosure) and the repeating unit of the long-chain structure make the polymer have the aforementioned advantages.

The preparation method adopted by the aliphatic copolycarbonate of the present disclosure is to carry out transesterification and polycondensation reaction with two monomers of dihydric alcohol and carbonate as monomers, and has the advantages of high product molecular weight, low polydispersity index, simple process, and lower cost.

### DETAILED DESCRIPTION

The technical solutions of the present disclosure will be described below in a definite and comprehensive manner with reference to specific embodiments. Apparently, the described embodiments are merely some of the embodiments of the present disclosure, rather than all of the embodiments. Based on the embodiments of the present disclosure, all other embodiments obtained by those of ordinary skill in the art without creative efforts shall fall in the scope of protection of the present disclosure.

It should be noted:

In the present invention, unless otherwise specified, all the embodiments and illustrated implementations mentioned herein may be combined with each other to form new technical solutions.

In the present disclosure, unless otherwise specified, all the technical features and illustrated features mentioned herein may be combined with each other to form new technical solutions.

A “range” disclosed herein may be in the form of a lower limit and an upper limit, which may be one or more lower limits, and one or more upper limits, respectively.

Unless otherwise defined, professional and scientific terms used herein have the same meanings as those familiar to those skilled in the art. In addition, any methods or materials similar or equivalent to those described may also be used in the present disclosure.

The present disclosure will be specifically described below in conjunction with specific embodiments. It is necessary to point out that the following embodiments are only used to further illustrate the present disclosure, and should not be construed as limitations on the protection scope of the present disclosure. Some non-essential improvements and adjustments made to the present disclosure by those skilled in the art according to the contents of the present disclosure still belong to the scope of protection of the present disclosure.

In the following examples and comparative examples, unless otherwise specified, the structural formula of tricyclodecanedimethanol is

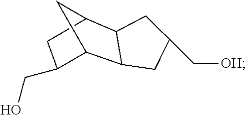 [SMILES: OCC1CC2C3CC(CO)C(C3)C2C1]

the structural formula of 1,4-cyclohexanedimethanol is

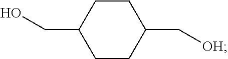

the structural formula of 4,4′-bicyclohexanol is

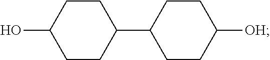 [SMILES: OC1CCC(C2CCC(O)CC2)CC1]

the structural formula of 2,2,4,4-tetramethyl-1,3-cyclobutanediol is

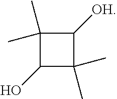

The above are all commercially available products.

The embodiments of the present disclosure are described with specific examples, and the results of each example are tested accordingly. Gel permeation chromatography (GPC) is used to measure the molecular weight and polydispersity of the polymer, and polystyrene is the standard sample and tetrahydrofuran is the mobile phase. The thermal properties and thermal stability of the polymers were characterized by differential scanning calorimetry (DSC) and thermogravimetric analysis (TGA), respectively.

### Embodiment 1

Diphenyl carbonate, 1,4-butanediol and tricyclodecane dimethanol (mol ratio is 1:0.9:0.1) are placed in the reactor simultaneously, and magnesium oxide is added as a catalyst (the dosage is 0.25% of the total moles of carbonate monomers or diol monomers). Under a high-purity nitrogen atmosphere, they are subjected to heating, melting and mixing uniformly, thus raising the temperature to 210° C., and the reaction time is 2 hours to obtain an oligomerized product.

Raise the temperature of the oligomerized product to 220° C., and at the same time gradually reduce the pressure in the reactor to 1.1 KPa. After the by-products are distilled off under reduced pressure, reduce the pressure in the reactor to below 200 Pa (100 Pa) for polycondensation, and the reaction is carried out. After 2 hours, an aliphatic copolycarbonate-poly(butylene carbonate-co-tricyclodecane dimethanol carbonate) is obtained.

According to GPC measurement and analysis, the weight-average molecular weight M_{w} of the copolycarbonate obtained in this example is 124797 g·mol⁻¹, the number-average molecular weight Mₙ is 72976 g·mol⁻¹, and the PDI is 1.71.

According to DSC measurement and analysis, the copolycarbonate has an amorphous state, no fixed melting point, and a glass transition temperature of −3.43° C.

According to TG measurement and analysis, the 5% thermal weight loss temperature T_{d,5%} of the product is 283.98° C., the maximum thermal weight loss rate temperature T_{d,max1} is 314.09° C., T_{d,max2} is 358.03° C.

### Embodiment 2

Diphenyl carbonate, 1,4-butanediol and tricyclodecane dimethanol (mol ratio is 1:0.8:0.2) are placed in the reactor simultaneously, and magnesium oxide is added as a catalyst (the dosage is 0.25% of the total moles of carbonate monomers or diol monomers). Under a high-purity nitrogen atmosphere, they are subjected to heating, melting and mixing uniformly, thus raising the temperature to 210° C., and the reaction time is 2 hours to obtain an oligomerized product. Raise the temperature of the oligomerized product to 220° C., and at the same time gradually reduce the pressure in the reactor to 1 KPa. After the by-products are distilled off under reduced pressure, reduce the pressure in the reactor to below 200 Pa (110 Pa) for polycondensation, and the reaction is carried out. After 2 hours, an aliphatic copolycarbonate-poly(butylene carbonate-co-tricyclodecane dimethanol carbonate) is obtained.

According to GPC measurement and analysis, the weight-average molecular weight M_{w} of the copolycarbonate obtained in this example is 116320 g·mol⁻¹, the number-average molecular weight Mₙ is 67735 g·mol⁻¹, and the PDI is 1.72. According to DSC measurement and analysis, the copolycarbonate has an amorphous state, no fixed melting point, and a glass transition temperature of 17.08° C. According to TG measurement and analysis, the 5% thermal weight loss temperature T_{d,5%} of the product is 306.72° C., the maximum thermal weight loss rate temperature T_{d,max1} is 336.23° C., T_{d,max2} is 381.20° C.

### Embodiment 3

Diphenyl carbonate, 1,4-butanediol and tricyclodecane dimethanol (mol ratio is 1:0.7:0.3) are placed in the reactor simultaneously, and magnesium oxide is added as a catalyst (the dosage is 0.25% of the total moles of carbonate monomers or diol monomers). Under a high-purity nitrogen atmosphere, they are subjected to heating, melting and mixing uniformly, thus raising the temperature to 210° C., and the reaction time is 2 hours to obtain an oligomerized product. Raise the temperature of the oligomerized product to 220° C., and at the same time gradually reduce the pressure in the reactor to 1 KPa. After the by-products are distilled off under reduced pressure, reduce the pressure in the reactor to below 200 Pa (120 Pa) for polycondensation, and the reaction is carried out. After 2 hours, an aliphatic copolycarbonate-poly(butylene carbonate-co-tricyclodecane dimethanol carbonate) is obtained.

According to GPC measurement and analysis, the weight-average molecular weight M_{w} of the copolycarbonate obtained in this example is 105969 g·mol⁻¹, the number-average molecular weight Mₙ is 61231 g·mol⁻¹, and the PDI is 1.73. According to DSC measurement and analysis, the copolycarbonate has an amorphous state, no fixed melting point, and a glass transition temperature of 28.63° C. According to TG measurement and analysis, the 5% thermal weight loss temperature T_{d,5%} of the product is 300.46° C., the maximum thermal weight loss rate temperature T_{d,max1} is 321.39° C., T_{d,max2} is 383.78° C.

### Embodiment 4

Diphenyl carbonate, 1,4-butanediol and tricyclodecane dimethanol (mol ratio is 1:0.6:0.4) are placed in the reactor simultaneously, and magnesium oxide is added as a catalyst (the dosage is 0.25% of the total moles of carbonate monomers or diol monomers). Under a high-purity nitrogen atmosphere, they are subjected to heating, melting and mixing uniformly, thus raising the temperature to 210° C., and the reaction time is 2 hours to obtain an oligomerized product. Raise the temperature of the oligomerized product to 220° C., and at the same time gradually reduce the pressure in the reactor to 1.1 KPa. After the by-products are distilled off under reduced pressure, reduce the pressure in the reactor to below 200 Pa (90 Pa) for polycondensation, and the reaction is carried out. After 2 hours, an aliphatic copolycarbonate-poly(butylene carbonate-co-tricyclodecane dimethanol carbonate) is obtained.

According to GPC measurement and analysis, the weight-average molecular weight M_{w} of the copolycarbonate obtained in this example is 73616 g·mol⁻¹, the number-average molecular weight Mₙ is 43301 g·mol⁻¹, and the PDI is 1.70. According to DSC measurement and analysis, the copolycarbonate has an amorphous state, no fixed melting point, and a glass transition temperature of 37.11° C. According to TG measurement and analysis, the 5% thermal weight loss temperature T_{d,5%} of the product is 294.44° C., the maximum thermal weight loss rate temperature T_{d,max1} is 331.40° C., T_{d,max2} is 373.26° C.

### Embodiment 5

Diphenyl carbonate, 1,4-butanediol and tricyclodecane dimethanol (mol ratio is 1:0.5:0.5) are placed in the reactor simultaneously, and magnesium oxide is added as a catalyst (the dosage is 0.25% of the total moles of carbonate monomers or diol monomers). Under a high-purity nitrogen atmosphere, they are subjected to heating, melting and mixing uniformly, thus raising the temperature to 210° C., and the reaction time is 2 hours to obtain an oligomerized product. Raise the temperature of the oligomerized product to 220° C., and at the same time gradually reduce the pressure in the reactor to 1.2 KPa. After the by-products are distilled off under reduced pressure, reduce the pressure in the reactor to below 200 Pa (130 Pa) for polycondensation, and the reaction is carried out. After 2 hours, an aliphatic copolycarbonate-poly(butylene carbonate-co-tri cyclodecane dimethanol carbonate) is obtained.

According to GPC measurement and analysis, the weight-average molecular weight M_{w} of the copolycarbonate obtained in this example is 35659 g·mol⁻¹, the number-average molecular weight Mₙ is 21772 g·mol⁻¹, and the PDI is 1.64. According to DSC measurement and analysis, the copolycarbonate has an amorphous state, no fixed melting point, and a glass transition temperature of 43.83° C. According to TG measurement and analysis, the 5% thermal weight loss temperature T_{d,5%} of the product is 317.28° C., the maximum thermal weight loss rate temperature T_{d,max} is 390.36° C.

### Embodiment 6

Diphenyl carbonate, 1,4-butanediol and tricyclodecane dimethanol (mol ratio is 1:0.4:0.6) are placed in the reactor simultaneously, and magnesium oxide is added as a catalyst (the dosage is 0.25% of the total moles of carbonate monomers or diol monomers). Under a high-purity nitrogen atmosphere, they are subjected to heating, melting and mixing uniformly, thus raising the temperature to 210° C., and the reaction time is 2 hours to obtain an oligomerized product. Raise the temperature of the oligomerized product to 220° C., and at the same time gradually reduce the pressure in the reactor to 1 KPa. After the by-products are distilled off under reduced pressure, reduce the pressure in the reactor to below 200 Pa (110 Pa) for polycondensation, and the reaction is carried out. After 2 hours, an aliphatic copolycarbonate-poly(butylene carbonate-co-tricyclodecane dimethanol carbonate) is obtained.

According to GPC measurement and analysis, the weight-average molecular weight M_{w} of the copolycarbonate obtained in this example is 26335 g·mol⁻¹, the number-average molecular weight Mₙ is 16197 g·mol⁻¹, and the PDI is 1.63. According to DSC measurement and analysis, the copolycarbonate has an amorphous state, no fixed melting point, and a glass transition temperature of 52.48° C. According to TG measurement and analysis, the 5% thermal weight loss temperature T_{d,5%} of the product is 314.64° C., the maximum thermal weight loss rate temperature T_{d,max} is 388.72° C.

### Embodiment 7

Diphenyl carbonate, 1,4-butanediol and tricyclodecane dimethanol (mol ratio is 1:0.3:0.7) are placed in the reactor simultaneously, and magnesium oxide is added as a catalyst (the dosage is 0.25% of the total moles of carbonate monomers or diol monomers). Under a high-purity nitrogen atmosphere, they are subjected to heating, melting and mixing uniformly, thus raising the temperature to 210° C., and the reaction time is 2 hours to obtain an oligomerized product. Raise the temperature of the oligomerized product to 220° C., and at the same time gradually reduce the pressure in the reactor to 1.1 KPa. After the by-products are distilled off under reduced pressure, reduce the pressure in the reactor to below 200 Pa (100 Pa) for polycondensation, and the reaction is carried out. After 2 hours, an aliphatic copolycarbonate-poly(butylene carbonate-co-tricyclodecane dimethanol carbonate) is obtained.

According to GPC measurement and analysis, the weight-average molecular weight M_{w} of the copolycarbonate obtained in this example is 29003 g·mol⁻¹, the number-average molecular weight Mₙ is 17813 g·mol⁻¹, and the PDI is 1.63. According to DSC measurement and analysis, the copolycarbonate has an amorphous state, no fixed melting point, and a glass transition temperature of 64.18° C. According to TG measurement and analysis, the 5% thermal weight loss temperature T_{d,5%} of the product is 307.48° C., the maximum thermal weight loss rate temperature T_{d,max} is 375.05° C.

### Embodiment 8

Diphenyl carbonate, 1,4-butanediol and tricyclodecane dimethanol (mol ratio is 1:0.2:0.8) are placed in the reactor simultaneously, and magnesium oxide is added as a catalyst (the dosage is 0.25% of the total moles of carbonate monomers or diol monomers). Under a high-purity nitrogen atmosphere, they are subjected to heating, melting and mixing uniformly, thus raising the temperature to 210° C., and the reaction time is 2 hours to obtain an oligomerized product. Raise the temperature of the oligomerized product to 220° C., and at the same time gradually reduce the pressure in the reactor to 1.1 KPa. After the by-products are distilled off under reduced pressure, reduce the pressure in the reactor to below 200 Pa (100 Pa) for polycondensation, and the reaction is carried out. After 2 hours, an aliphatic copolycarbonate-poly(butylene carbonate-co-tricyclodecane dimethanol carbonate) is obtained.

According to GPC measurement and analysis, the weight-average molecular weight M_{w} of the copolycarbonate obtained in this example is 12369 g·mol⁻¹, the number-average molecular weight Mₙ is 7756 g·mol⁻¹, and the PDI is 1.59. According to DSC measurement and analysis, the copolycarbonate has an amorphous state, no fixed melting point, and a glass transition temperature of 66.65° C. According to TG measurement and analysis, the 5% thermal weight loss temperature T_{d,5%} of the product is 332.28° C., the maximum thermal weight loss rate temperature T_{d,max} is 392.45° C.

### Embodiment 9

Diphenyl carbonate, 1,4-butanediol and tricyclodecane dimethanol (mol ratio is 1:0.1:0.9) are placed in the reactor simultaneously, and magnesium oxide is added as a catalyst (the dosage is 0.25% of the total moles of carbonate monomers or diol monomers). Under a high-purity nitrogen atmosphere, they are subjected to heating, melting and mixing uniformly, thus raising the temperature to 210° C., and the reaction time is 2 hours to obtain an oligomerized product. Raise the temperature of the oligomerized product to 220° C., and at the same time gradually reduce the pressure in the reactor to 1.1 KPa. After the by-products are distilled off under reduced pressure, reduce the pressure in the reactor to below 200 Pa (90 Pa) for polycondensation, and the reaction is carried out. After 2 hours, an aliphatic copolycarbonate-poly(butylene carbonate-co-tricyclodecane dimethanol carbonate) is obtained.

According to GPC measurement and analysis, the weight-average molecular weight M_{w} of the copolycarbonate obtained in this example is 10451 g·mol⁻¹, the number-average molecular weight Mₙ is 6331 g·mol⁻¹, and the PDI is 1.65. According to DSC measurement and analysis, the copolycarbonate has an amorphous state, no fixed melting point, and a glass transition temperature of 70.90° C. According to TG measurement and analysis, the 5% thermal weight loss temperature T_{d,5%} of the product is 327.41° C., the maximum thermal weight loss rate temperature T_{d,max} is 379.99° C.

### Embodiment 10

Diphenyl carbonate, 1,4-butanediol and 1,4-cyclohexanedimethanol (mol ratio is 1:0.9:0.1) are placed in the reactor simultaneously, and magnesium oxide is added as a catalyst (the dosage is 0.15% of the total moles of carbonate monomers or diol monomers). Under a high-purity nitrogen atmosphere, they are subjected to heating, melting and mixing uniformly, thus raising the temperature to 210° C., and the reaction time is 2 hours to obtain an oligomerized product. Raise the temperature of the oligomerized product to 220° C., and at the same time gradually reduce the pressure in the reactor to 1 KPa. After the by-products are distilled off under reduced pressure, reduce the pressure in the reactor to below 200 Pa (80 Pa) for polycondensation, and the reaction is carried out. After 2 hours, an aliphatic copolycarbonate-poly(butylene carbonate-co-1,4-cyclohexanedimethanol carbonate) is obtained.

According to GPC measurement and analysis, the weight-average molecular weight M_{w} of the copolycarbonate obtained in this example is 83506 g·mol⁻¹, the number-average molecular weight Mₙ is 48263 g·mol⁻¹, and the PDI is 1.73. According to DSC measurement and analysis, the copolycarbonate has an amorphous state, no fixed melting point, and a glass transition temperature of −17.85° C. According to TG measurement and analysis, the 5% thermal weight loss temperature T_{d,5%} of the product is 294.03° C., the maximum thermal weight loss rate temperature T_{d,max} is 332.12° C.

### Embodiment 11

Diphenyl carbonate, 1,4-butanediol and 1,4-cyclohexanedimethanol (mol ratio is 1:0.7:0.3) are placed in the reactor simultaneously, and magnesium oxide is added as a catalyst (the dosage is 0.15% of the total moles of carbonate monomers or diol monomers). Under a high-purity nitrogen atmosphere, they are subjected to heating, melting and mixing uniformly, thus raising the temperature to 210° C., and the reaction time is 2 hours to obtain an oligomerized product. Raise the temperature of the oligomerized product to 220° C., and at the same time gradually reduce the pressure in the reactor to 1 KPa. After the by-products are distilled off under reduced pressure, reduce the pressure in the reactor to below 200 Pa (80 Pa) for polycondensation, and the reaction is carried out. After 2 hours, an aliphatic copolycarbonate-poly(butylene carbonate-co-1,4-cyclohexanedimethanol carbonate) is obtained.

According to GPC measurement and analysis, the weight-average molecular weight M_{w} of the copolycarbonate obtained in this example is 102836 g·mol⁻¹, the number-average molecular weight Mₙ is 56720 g·mol⁻¹, and the PDI is 1.81. According to DSC measurement and analysis, the copolycarbonate has an amorphous state, no fixed melting point, and a glass transition temperature of 1.28° C. According to TG measurement and analysis, the 5% thermal weight loss temperature T_{d,5%} of the product is 313.01° C., the maximum thermal weight loss rate temperature T_{d,max} is 356.17° C.

### Embodiment 12

Diphenyl carbonate, 1,4-butanediol and 1,4-cyclohexanedimethanol (mol ratio is 1:0.5:0.5) are placed in the reactor simultaneously, and magnesium oxide is added as a catalyst (the dosage is 0.15% of the total moles of carbonate monomers or diol monomers). Under a high-purity nitrogen atmosphere, they are subjected to heating, melting and mixing uniformly, thus raising the temperature to 210° C., and the reaction time is 2 hours to obtain an oligomerized product. Raise the temperature of the oligomerized product to 220° C., and at the same time gradually reduce the pressure in the reactor to 1 KPa. After the by-products are distilled off under reduced pressure, reduce the pressure in the reactor to below 200 Pa (90 Pa) for polycondensation, and the reaction is carried out. After 2 hours, an aliphatic copolycarbonate-poly(butylene carbonate-co-1,4-cyclohexanedimethanol carbonate) is obtained.

According to GPC measurement and analysis, the weight-average molecular weight M_{w} of the copolycarbonate obtained in this example is 100852 g·mol⁻¹, the number-average molecular weight Mₙ is 53356 g·mol⁻¹, and the PDI is 1.89. According to DSC measurement and analysis, the copolycarbonate has an amorphous state, no fixed melting point, and a glass transition temperature of 16.78° C. According to TG measurement and analysis, the 5% thermal weight loss temperature T_{d,5%} of the product is 320.71° C., the maximum thermal weight loss rate temperature T_{d,max} is 365.94° C.

### Embodiment 13

Diphenyl carbonate, 1,4-butanediol and 1,4-cyclohexanedimethanol (mol ratio is 1:0.3:0.7) are placed in the reactor simultaneously, and magnesium oxide is added as a catalyst (the dosage is 0.15% of the total moles of carbonate monomers or diol monomers). Under a high-purity nitrogen atmosphere, they are subjected to heating, melting and mixing uniformly, thus raising the temperature to 210° C., and the reaction time is 2 hours to obtain an oligomerized product. Raise the temperature of the oligomerized product to 220° C., and at the same time gradually reduce the pressure in the reactor to 1 KPa. After the by-products are distilled off under reduced pressure, reduce the pressure in the reactor to below 200 Pa (80 Pa) for polycondensation, and the reaction is carried out. After 2 hours, an aliphatic copolycarbonate-poly(butylene carbonate-co-1,4-cyclohexanedimethanol carbonate) is obtained.

According to GPC measurement and analysis, the weight-average molecular weight M_{w} of the copolycarbonate obtained in this example is 141555 g·mol⁻¹, the number-average molecular weight Mₙ is 77061 g·mol⁻¹, and the PDI is 1.84. According to DSC measurement and analysis, the copolycarbonate has an amorphous state, no fixed melting point, and a glass transition temperature of 30.14° C. According to TG measurement and analysis, the 5% thermal weight loss temperature T_{d,5%} of the product is 313.95° C., the maximum thermal weight loss rate temperature T_{d,max} is 370.10° C.

### Embodiment 14

Diphenyl carbonate, 1,4-butanediol and 1,4-cyclohexanedimethanol (mol ratio is 1:0.1:0.9) are placed in the reactor simultaneously, and magnesium oxide is added as a catalyst (the dosage is 0.15% of the total moles of carbonate monomers or diol monomers). Under a high-purity nitrogen atmosphere, they are subjected to heating, melting and mixing uniformly, thus raising the temperature to 210° C., and the reaction time is 2 hours to obtain an oligomerized product. Raise the temperature of the oligomerized product to 220° C., and at the same time gradually reduce the pressure in the reactor to 1 KPa. After the by-products are distilled off under reduced pressure, reduce the pressure in the reactor to below 200 Pa (80 Pa) for polycondensation, and the reaction is carried out. After 2 hours, an aliphatic copolycarbonate-poly(butylene carbonate-co-1,4-cyclohexanedimethanol carbonate) is obtained.

According to GPC measurement and analysis, the weight-average molecular weight M_{w} of the copolycarbonate obtained in this example is 113326 g·mol⁻¹, the number-average molecular weight Mₙ is 62186 g·mol⁻¹, and the PDI is 1.82. According to DSC measurement and analysis, the copolycarbonate has an amorphous state, no fixed melting point, and a glass transition temperature of 42.34° C. According to TG measurement and analysis, the 5% thermal weight loss temperature T_{d,5%} of the product is 330.79° C., the maximum thermal weight loss rate temperature T_{d,max} is 371.61° C.

### Embodiment 15

Diphenyl carbonate, 1,4-butanediol, and 4,4′-bicyclohexanol (mol ratio is 1:0.9:0.1) are placed in the reactor simultaneously, and magnesium oxide is added as a catalyst (the dosage is 0.15% of the total moles of carbonate monomers or diol monomers). Under a high-purity nitrogen atmosphere, they are subjected to heating, melting and mixing uniformly, thus raising the temperature to 210° C., and the reaction time is 2 hours to obtain an oligomerized product. Raise the temperature of the oligomerized product to 220° C., and at the same time gradually reduce the pressure in the reactor to 1 KPa. After the by-products are distilled off under reduced pressure, reduce the pressure in the reactor to below 200 Pa (100 Pa) for polycondensation, and the reaction is carried out. After 2 hours, an aliphatic copolycarbonate-poly(butylene carbonate-co-4,4′-bicyclohexanol carbonate) is obtained.

According to GPC measurement and analysis, the weight-average molecular weight M_{w} of the copolycarbonate obtained in this example is 31744 g·mol⁻¹, the number-average molecular weight Mₙ is 18893 g·mol⁻¹, and the PDI is 1.68. According to DSC measurement and analysis, the copolycarbonate has an amorphous state, no fixed melting point, and a glass transition temperature of −14.18° C. According to TG measurement and analysis, the 5% thermal weight loss temperature T_{d,5%} of the product is 274.26° C., the maximum thermal weight loss rate temperature T_{d,max} is 306.73° C.

### Embodiment 16

Diphenyl carbonate, 1,4-butanediol, and 2,2,4,4-tetramethyl-1,3-cyclobutanediol (mol ratio is 1:0.9:0.1) are placed in the reactor simultaneously, and magnesium oxide is added as a catalyst (the dosage is 0.15% of the total moles of carbonate monomers or diol monomers). Under a high-purity nitrogen atmosphere, they are subjected to heating, melting and mixing uniformly, thus raising the temperature to 190° C., and the reaction time is 2 hours to obtain an oligomerized product. Raise the temperature of the oligomerized product to 210° C., and at the same time gradually reduce the pressure in the reactor to 1 KPa. After the by-products are distilled off under reduced pressure, reduce the pressure in the reactor to below 200 Pa (100 Pa) for polycondensation, and the reaction is carried out. After 2 hours, an aliphatic copolycarbonate-poly(butylene carbonate-co-2,2,4,4-tetramethyl-1,3-cyclobutanediol carbonate) is obtained.

According to GPC measurement and analysis, the weight-average molecular weight M_{w} of the copolycarbonate obtained in this example is 23958 g·mol⁻¹, the number-average molecular weight Mₙ is 14919 g·mol⁻¹, and the PDI is 1.61. According to DSC measurement and analysis, the melting point of the copolycarbonate is 41.81° C., the melting enthalpy ΔHₘ is 7.94 J/g, and the glass transition temperature is −30.29° C. According to TG measurement and analysis, the 5% thermal weight loss temperature T_{d,5%} of the product is 270.71° C., the maximum thermal weight loss rate temperature T_{d,max} is 311.84° C.

### Embodiment 17

Diphenyl carbonate, 1,4-butanediol, and 2,2,4,4-tetramethyl-1,3-cyclobutanediol (mol ratio is 1:0.7:0.3) are placed in the reactor simultaneously, and magnesium oxide is added as a catalyst (the dosage is 0.15% of the total moles of carbonate monomers or diol monomers). Under a high-purity nitrogen atmosphere, they are subjected to heating, melting and mixing uniformly, thus raising the temperature to 190° C., and the reaction time is 2 hours to obtain an oligomerized product. Raise the temperature of the oligomerized product to 210° C., and at the same time gradually reduce the pressure in the reactor to 1 KPa. After the by-products are distilled off under reduced pressure, reduce the pressure in the reactor to below 200 Pa (100 Pa) for polycondensation, and the reaction is carried out. After 2 hours, an aliphatic copolycarbonate-poly(butylene carbonate-co-2,2,4,4-tetramethyl-1,3-cyclobutanediol carbonate) is obtained.

According to GPC measurement and analysis, the weight-average molecular weight M_{w} of the copolycarbonate obtained in this example is 18054 g·mol⁻¹, the number-average molecular weight Mₙ is 10639 g·mol⁻¹, and the PDI is 1.70. According to DSC measurement and analysis, the copolycarbonate has an amorphous state, no fixed melting point, and a glass transition temperature of −12.53° C. According to TG measurement and analysis, the 5% thermal weight loss temperature T_{d,5%} of the product is 279.11° C., the maximum thermal weight loss rate temperature T_{d,max} is 315.42° C.

### Embodiment 18

Diphenyl carbonate, 1,4-butanediol, and 2,2,4,4-tetramethyl-1,3-cyclobutanediol (mol ratio is 1:0.5:0.5) are placed in the reactor simultaneously, and magnesium oxide is added as a catalyst (the dosage is 0.15% of the total moles of carbonate monomers or diol monomers). Under a high-purity nitrogen atmosphere, they are subjected to heating, melting and mixing uniformly, thus raising the temperature to 190° C., and the reaction time is 2 hours to obtain an oligomerized product. Raise the temperature of the oligomerized product to 210° C., and at the same time gradually reduce the pressure in the reactor to 1 KPa. After the by-products are distilled off under reduced pressure, reduce the pressure in the reactor to below 200 Pa (90 Pa) for polycondensation, and the reaction is carried out. After 2 hours, an aliphatic copolycarbonate-poly(butylene carbonate-co-2,2,4,4-tetramethyl-1,3-cyclobutanediol carbonate) is obtained.

According to GPC measurement and analysis, the weight-average molecular weight M_{w} of the copolycarbonate obtained in this example is 13722 g·mol⁻¹, the number-average molecular weight Mₙ is 8406 g·mol⁻¹, and the PDI is 1.63. According to DSC measurement and analysis, the copolycarbonate has an amorphous state, no fixed melting point, and a glass transition temperature of 11.53° C. According to TG measurement and analysis, the 5% thermal weight loss temperature T_{d,5%} of the product is 295.58° C., the maximum thermal weight loss rate temperature T_{d,max} is 329.22° C.

### Embodiment 19

Diphenyl carbonate, 1,4-butanediol, and 2,2,4,4-tetramethyl-1,3-cyclobutanediol (mol ratio is 1:0.3:0.7) are placed in the reactor simultaneously, and magnesium oxide is added as a catalyst (the dosage is 0.15% of the total moles of carbonate monomers or diol monomers). Under a high-purity nitrogen atmosphere, they are subjected to heating, melting and mixing uniformly, thus raising the temperature to 190° C., and the reaction time is 2 hours to obtain an oligomerized product. Raise the temperature of the oligomerized product to 210° C., and at the same time gradually reduce the pressure in the reactor to 1 KPa. After the by-products are distilled off under reduced pressure, reduce the pressure in the reactor to below 200 Pa (100 Pa) for polycondensation, and the reaction is carried out. After 2 hours, an aliphatic copolycarbonate-poly(butylene carbonate-co-2,2,4,4-tetramethyl-1,3-cyclobutanediol carbonate) is obtained.

According to GPC measurement and analysis, the weight-average molecular weight M_{w} of the copolycarbonate obtained in this example is 9012 g·mol⁻¹, the number-average molecular weight Mₙ is 5380 g·mol⁻¹, and the PDI is 1.68. According to DSC measurement and analysis, the copolycarbonate has an amorphous state, no fixed melting point, and a glass transition temperature of 31.55° C. According to TG measurement and analysis, the 5% thermal weight loss temperature T_{d,5%} of the product is 307.37° C., the maximum thermal weight loss rate temperature T_{d,max} is 342.43° C.

### Embodiment 20

The aliphatic copolycarbonate is prepared according to the method of Embodiment 13, except that the process is replaced by the following method: Diphenyl carbonate, 1,4-butanediol and 1,4-cyclohexanedimethanol (mol ratio is 1:0.3:0.7) are placed in the reactor simultaneously, and magnesium oxide is added as a catalyst (the dosage is 0.15% of the total moles of carbonate monomers or diol monomers). Under a high-purity nitrogen atmosphere, they are subjected to heating, melting and mixing uniformly, thus raising the temperature to 210° C., and the reaction time is 2 hours to obtain an oligomerized product. The temperature of the oligomerized product is raised to 220° C., and the pressure in the reactor was gradually lowered to about 500 Pa, and the reaction was continued for 2 hours. The obtained product was measured by GPC to find that he weight-average molecular weight M_{w} is 35304 g·mol⁻¹, and the number-average molecular weight is Mₙ was 17349 g·mol⁻¹, and PDI was 2.03.

### Comparison Embodiment

Diphenyl carbonatebutanediol and 1,4-butanediol (mol ratio is 1:1) are placed in the reactor simultaneously, and magnesium oxide is added as a catalyst (the dosage is 0.15% of the total moles of carbonate monomers or diol monomers). Under a high-purity nitrogen atmosphere, they are subjected to heating, melting and mixing uniformly, thus raising the temperature to 200° C., and the reaction time is 2 hours to obtain an oligomerized product. Raise the temperature of the oligomerized product to 220° C., and at the same time gradually reduce the pressure in the reactor to 1 KPa. After the by-products are distilled off under reduced pressure, reduce the pressure in the reactor to below 200 Pa (90 Pa) for polycondensation, and the reaction is carried out. After 2 hours, polybutylene carbonate is obtained.

According to GPC measurement and analysis, the weight-average molecular weight M_{w} of the copolycarbonate obtained in this example is 129660 g·mol⁻¹, the number-average molecular weight Mₙ is 93498 g·mol⁻¹, and the PDI is 1.39. The melting point of the polycarbonate is 61.15° C., the melting enthalpy ΔHₘ is 66.56 J/g, and the glass transition temperature is −30.28° C.

According to TG measurement and analysis, the 5% thermal weight loss temperature T_{d,5%} of the product is 285.24° C., the maximum thermal weight loss rate temperature T_{d,max} is 323.93° C.

Compared with the polybutylene carbonate obtained in the comparative example, the glass transition temperature and thermal stability of the copolycarbonate obtained in the embodiments of the present disclosure have been significantly improved. In particular, the copolycarbonates obtained in Embodiments 2-4 and 10-14 have relatively high molecular weights while improving the thermal properties.

By comparing the Comparison embodiment with Embodiment 3 and Embodiment 13, it can be seen that under the condition of similar molecular weights, the glass transition temperature of Embodiment 3 and Embodiment 13 is increased by nearly 60° C., and the Td, 5% also increased to above 300° C., and the thermal performance is significantly improved.

Finally, it should be noted that the above embodiments are merely used to illustrate the technical solutions of the present disclosure, but not to limit them. Although the present disclosure has been described in detail with reference to the foregoing embodiments, those of ordinary skill in the art should understand that the technical solutions described in the foregoing embodiments can still be modified, or some or all of the technical features thereof can be equivalently replaced. However, these modifications or substitutions do not make the essence of the corresponding technical solutions deviate from the scope of the technical solutions of the embodiments of the present disclosure.

What is claimed is:

1. An aliphatic copolycarbonate comprising a structural unit represented by formula (1) and a structural unit represented by formula (2): 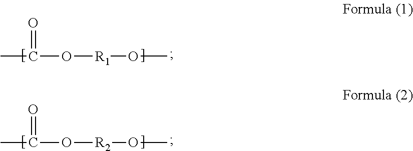
wherein R₁ is a C₃-C₁₀ alkylene group, and R₂ is an alicyclic group.

2. The aliphatic copolycarbonate of claim 1, wherein R₁ is a C₃-C₁₀ straight-chain alkylene.

3. The aliphatic copolycarbonate of claim 2, wherein R₁ is a C₄, C₆, C₈, or C₁₀ straight-chain alkylene.

4. The aliphatic copolycarbonate of claim 2, wherein R₂ is one or more selected from the following alicyclic groups:

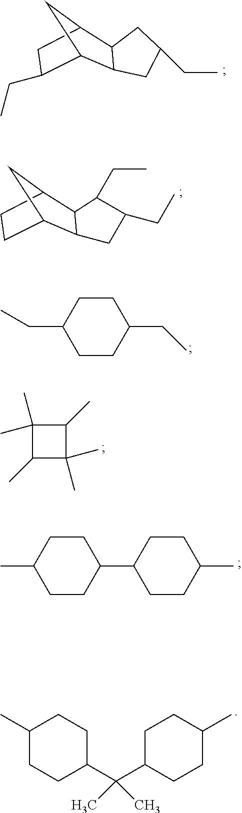

5. The aliphatic copolycarbonate of claim 1, wherein based on a total molar amount of structural units in the aliphatic copolycarbonate as 100%, a molar content of the structural unit represented by formula (1) is 10%-90%, and a molar content of the structural unit represented by formula (2) is 10%-90%;
wherein when R₂ is 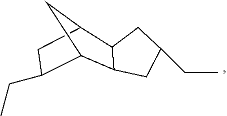
the molar content of the structural unit represented by the formula (1) is 10%-80%, and the molar content of the structural unit represented by the formula (2) is 20%-90%;
when R₂ is 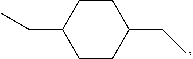
the molar content of the structural unit represented by the formula (1) is 10%-80%, and the molar content of the structural unit represented by the formula (2) is 20%-90%;
when R₂ is 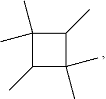
the molar content of the structural unit represented by the formula (1) is 10%-60%, and the molar content of the structural unit represented by the formula (2) is 40%-90%; and
when R₂ is 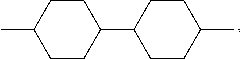
the molar content of the structural unit represented by the formula (1) is 10%-70%, and the molar content of the structural unit represented by the formula (2) is 30%-90%.

6. The aliphatic copolycarbonate of claim 1, wherein a weight-average molecular weight of the aliphatic copolycarbonate is 9×10³-14×10⁴;
wherein when R₂ is 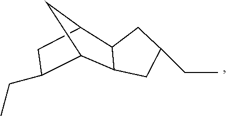
the weight-average molecular weight of the aliphatic copolycarbonate is 3×10⁴-14×10⁴; when R₂ is 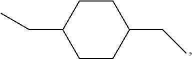
the weight-average molecular weight of the aliphatic copolycarbonate is 8×10⁴-14×10⁴; when R₂ is 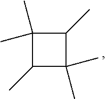
the weight-average molecular weight of the aliphatic copolycarbonate is 2×10⁴-14×10⁴; and when R₂ is 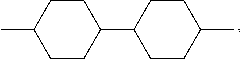
the weight-average molecular weight of the aliphatic copolycarbonate is 3×10⁴-14×10⁴.

7. The aliphatic copolycarbonate of claim 6, wherein the weight-average molecular weight of the aliphatic copolycarbonate is 2×10⁴-14×10⁴.

8. The aliphatic copolycarbonate of claim 1, wherein a number-average molecular weight of the aliphatic copolycarbonate is 5×10³-8×10⁴; wherein when R₂ is 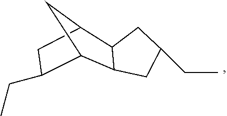
the number-average molecular weight of the aliphatic copolycarbonate is 2×10⁴-8×10⁴; when R₂ is 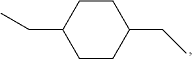
the number-average molecular weight of the aliphatic copolycarbonate is 4×10⁴-8×10⁴; when R₂ is 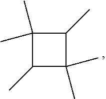
the number-average molecular weight of the aliphatic copolycarbonate is 1×10⁴-8×10⁴; and when R₂ is 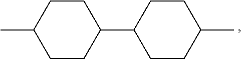
the number-average molecular weight of the aliphatic copolycarbonate is 1×10⁴-8×10⁴.

9. The aliphatic copolycarbonate of claim 8, wherein the number-average molecular weight of the aliphatic copolycarbonate is 1×10⁴-8×10⁴.

10. The aliphatic copolycarbonate of claim 8, wherein a polydispersity index of the aliphatic copolycarbonate is 1.5-2.1.

11. The aliphatic copolycarbonate of claim 10, wherein the polydispersity index of the aliphatic copolycarbonate is 1.59-1.89.

12. The aliphatic copolycarbonate of claim 1, wherein a glass transition temperature of the aliphatic copolycarbonate is (−30.29)-70.9° C., as measured and analyzed by differential scanning;
by thermogravimetric measurement and analysis, a 5% thermal weight loss temperature of the aliphatic copolycarbonate is 270.71-330.79° C.;
by the thermogravimetric measurement and analysis, a maximum thermogravimetric rate temperature of the aliphatic copolycarbonate is 306.73-392.45° C.

13. The aliphatic copolycarbonate of claim 12, wherein the glass transition temperature of the aliphatic copolycarbonate is 0-70.90° C., wherein the 5% thermal weight loss temperature of the aliphatic copolycarbonate is 271-330° C., and wherein the maximum thermogravimetric rate temperature of the aliphatic copolycarbonate is 307-392° C.

14. A method for preparing the aliphatic copolycarbonate of claim 1, comprising:
(1) subjecting the diol monomer represented by formula (3), the diol monomer represented by formula (4), and a carbonate monomer to melt polycondensation in the presence of a catalyst and in an inert atmosphere to obtain a prepolymerized product; 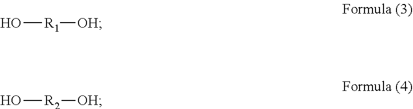
(2) removing by-products in the prepolymerized product obtained in operation (1), and then performing a polymerization reaction to obtain the aliphatic copolycarbonate.

15. The method of claim 14, wherein conditions for the pre-polymerization in operation (1) comprise:
the temperature is 140-220° C., and/or, the reaction time is 1-5 hours; and/or, the inert atmosphere is provided by nitrogen and/or an inert gas; and/or,
wherein conditions for polymerization in operation (2) comprise:
the temperature is 150-240° C., and/or, the time is 1-5 hours, and/or, the pressure is not higher than 200 Pa; and/or,
the method for removing the by-products in the prepolymerized product obtained in operation (1) is vacuum distillation, wherein the temperature of the vacuum distillation is 150-240° C., and the pressure is 2×10²-2×10⁴ Pa.

16. The method of claim 15, wherein in the conditions for polymerization in operation (2), the pressure is 10-150 Pa.

17. The method of claim 14, wherein a ratio of a total molar amount of the carbonate monomer to a total molar amount of the diol monomer represented by formula (3) and the diol monomer represented by formula (4) is 1:(1-1.5); and/or,
the diol monomer represented by formula (4) is selected as at least one of the following compounds: 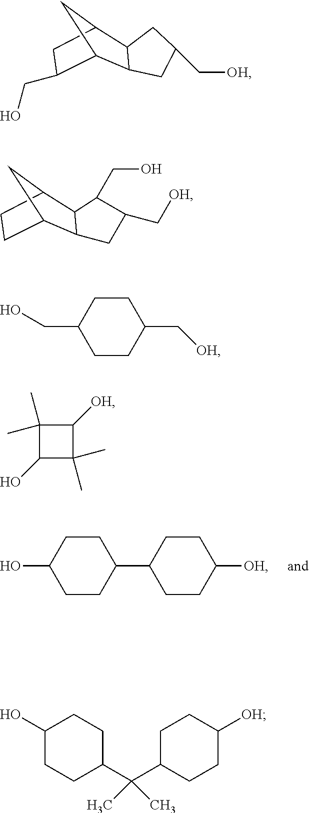
and/or,
the carbonate monomer is selected from at least one of dimethyl carbonate, diethyl carbonate, dipropyl carbonate, dibutyl carbonate, dihexyl carbonate, dioctyl carbonate, ethyl methyl carbonate, and diphenyl carbonate.

18. The method of claim 14, wherein the catalyst is one or more selected from the group consisting of oxide-type solid bases, inorganic metal salts and organic bases; and/or,
based on a total molar amount of the diol monomer represented by formula (3) and the diol monomer represented by formula (4) or the molar amount of the carbonate monomer as 100 parts, the amount of the catalyst used is 0.1-1 part.
